(19) United States
(12) Patent Application Publication
(10) Pub. No.: US 2026/0267939 A1
(43) Pub. Date: Sep. 10, 2026

(54) LINEAR ATTENTION IN VISION TRANSFORMER WITH QUADRATIC TAYLOR EXPANSION

(71) Applicant: Xilinx, Inc., San Jose, CA (US)

(72) Inventors: Yixing Xu, Beijing (CN); Chao Li, Beijing (CN); Dong Li, Beijing (CN); Fan Jiang, Beijing (CN); Lu Tian, Beijing (CN); Emad Barsoum, Sammamish, WA (US)

(21) Appl. No.: 19/074,005

(22) Filed: Mar. 7, 2025

(51) Int. Cl. G06F 17/17; G06F 7/78

(52) U.S. Cl. CPC G06F 17/17; G06F 7/78

(57) ABSTRACT

An apparatus and method for efficiently performing efficient data storage and data transfer of machine learning data. In various implementations, one of the multiple processing circuits of the computing system retrieves matrix of machine learning (ML) model weights (or weights). The processing circuit generates the Kronecker product for each vector (row) of the retrieved query weights matrix. The processing circuit replaces, for each vector (row), each element of the vector (row) with a self-multiplication term. The processing circuit scales, for each vector (row), each element of the vector (row) where the scales are dependent on the denominator of the terms. The processing circuit performs these steps for each element of each vector (row) of the key weights matrix. The processing circuit generates the dot product of the transformed query weights matrix and the transformed key weights matrix.

### BACKGROUND

### Description of the Relevant Art

The parallelization of tasks is used to increase the throughput of computing systems. To this end, compilers extract parallelized tasks from applications to execute in parallel on the computing system hardware. Parallel data processing circuits execute multiple threads simultaneously in order to take advantage of the identified instruction-level parallelism. The performance of computing systems increases with the scheduling of parallel data tasks on parallel data processing circuits. One or more of these parallel data processing circuits can support a machine learning (ML) model. The ML model uses machine learning techniques that rely on one of a variety of types of neural network structures. The ML model uses one or more layers of nodes to generate an output value representing a prediction when given a set of input data values.

With the addition of one or more parallel data processing circuits, the computing system hardware supports the data computing requirements of executing the instructions of the ML model. However, the computing system hardware also needs to support the data storage requirements, the memory bandwidth requirements, and the increasing demand for lower latencies of the ML model. The ML models, such as large language models (LLMs) and vision transformer (ViT) models, rely on multiple transformer stages that repeatedly operate self-attention mathematical techniques. These techniques have mathematical operations that have a latency proportional to the quadratic of the number of input values received by the ML model. With multiple stages and layers in the ML model, the latency continues to grow based on the quadratic relationship with the number of input values received by the ML model. Therefore, the performance suffers for the computing device executing the ML model.

In view of the above, methods and apparatuses for efficient execution of repetitive operations of a machine learning model are desired.

### BRIEF DESCRIPTION OF THE DRAWINGS

FIG. 1 is a generalized diagram of a computing system that provides efficient execution of repetitive operations of a machine learning model.

FIG. 2 is a generalized diagram of a machine learning model that provides efficient execution of repetitive operations of a machine learning model.

FIG. 3 is a generalized diagram of a machine learning initial attention stage that provides efficient execution of repetitive operations of a machine learning model.

FIG. 4A is a generalized diagram of an attention layer of a machine learning model that provides efficient execution of repetitive operations of a machine learning model.

FIG. 4B is a generalized diagram of operations used to create efficient repetitive operations of a machine learning model.

FIG. 4C is a generalized diagram of operations used to create efficient repetitive operations of a machine learning model.

FIG. 4D is a generalized diagram of operations used to create efficient repetitive operations of a machine learning model.

FIG. 5 is a generalized diagram of encoder and decoder block components of a machine learning model that provide efficient execution of repetitive operations of a machine learning model.

FIG. 6 is a generalized diagram of processing stages of a transformer of a machine learning model that provides efficient execution of repetitive operations of a machine learning model.

FIG. 7 is a generalized diagram of a computational graph of a machine learning model.

FIG. 8 is a generalized diagram of a method for performing efficient execution of repetitive operations of a machine learning model.

FIG. 9 is a generalized diagram of a computing system that performs efficient execution of repetitive operations of a machine learning model.

FIG. 10 is a generalized diagram of an apparatus that performs efficient execution of repetitive operations of a machine learning model.

FIG. 11 is a generalized diagram of a method for performing efficient data storage and data transfer of machine learning data.

While the invention is susceptible to various modifications and alternative forms, specific implementations are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the scope of the present invention as defined by the appended claims.

### DETAILED DESCRIPTION

In the following description, numerous specific details are set forth to provide a thorough understanding of the present invention. However, one having ordinary skill in the art should recognize that the invention might be practiced without these specific details. In some instances, well-known circuits, structures, and techniques have not been shown in detail to avoid obscuring the present invention. Further, it will be appreciated that for simplicity and clarity of illustration, elements shown in the figures have not necessarily been drawn to scale. For example, the dimensions of some of the elements are exaggerated relative to other elements.

Apparatuses and methods for performing efficient data storage and data transfer of machine learning data are disclosed. In various implementations, the host processing circuit of the computing system executes a machine learning (ML) parallel data application. In some implementations, the ML model is one of a variety of types of a large language model (LLM). In various implementations, the application is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call. The imported ML libraries are used to create a computational graph that provides the computational order of the ML nodes, layers and stages of the ML model. The host processing circuit uses a library that relies on a user mode driver (UMD) to translate function calls in the application to commands particular to a piece of hardware such as an accelerator circuit with a parallel data microarchitecture.

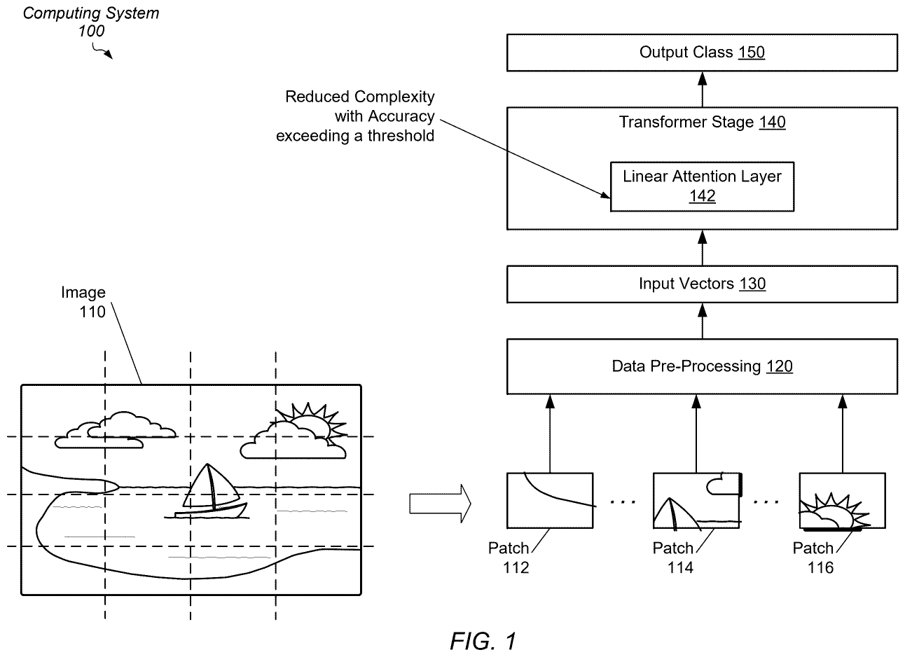

One of the multiple processing circuits of the computing system retrieves a matrix of machine learning (ML) model weights (or weights). The processing circuit generates the Kronecker product for each vector (row) of the retrieved query weights matrix. The processing circuit replaces, for each vector (row), each element of the vector (row) with a self-multiplication term. The processing circuit scales, for each vector (row), each element of the vector (row) where the scales are dependent on the denominator of the terms. The processing circuit performs these steps for each element of each vector (row) of the key weights matrix. The processing circuit generates the dot product of the transformed query weights matrix and the transformed key weights matrix. Further details of these techniques for performing efficient data storage and data transfer of machine learning data are provided in the following description of FIGS. 1-10.

Turning now to FIG. 1, a generalized diagram is shown of weights pruning 100 that performs efficient data storage and data transfer of machine learning model data. As shown, image 110 (still photograph or video still) is partitioned (or subdivided) into multiple patches 112, 114 and 116 and sent to a machine learning (ML) model for classification. Data pre-processing stage 120 receives the patches 112-116 and generates the input vectors 130, which are sent to the transformer stage 140. Based on at least the input vectors 130, transformer stage 140 generates the output class 150, which identifies one or more objects in image 110. Although three patches are shown, it is understood that any number of patches are generated from image 110. Similarly, although a single transformer stage 140 is shown, it is understood that any number of transformer stages are used based on design requirements. For example, a large language model (LLM), such as a vision transformer (ViT) model, typically utilizes multiple connected transformer stages between the input patches 112-116 and the output class 150.

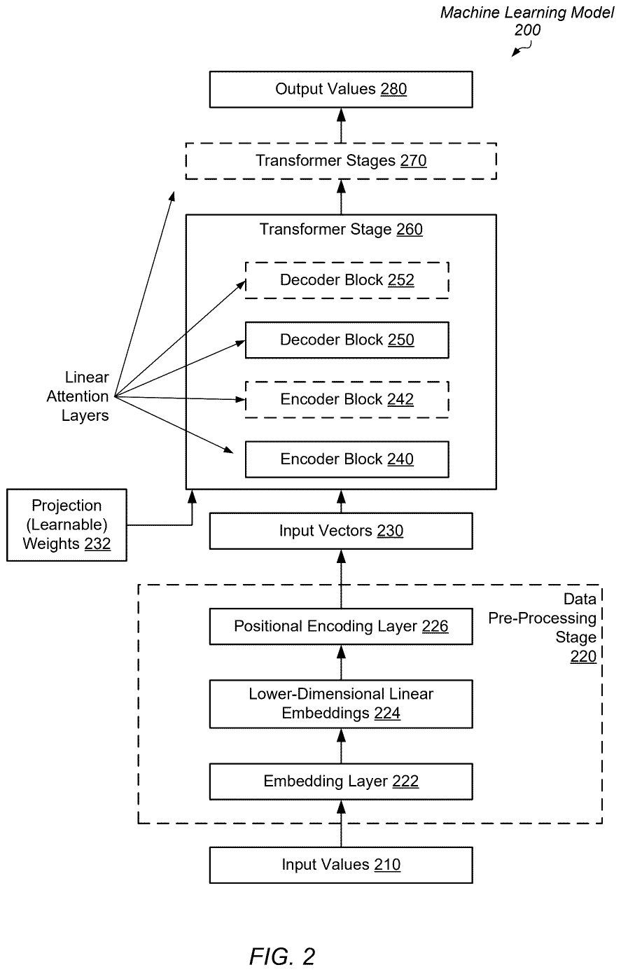

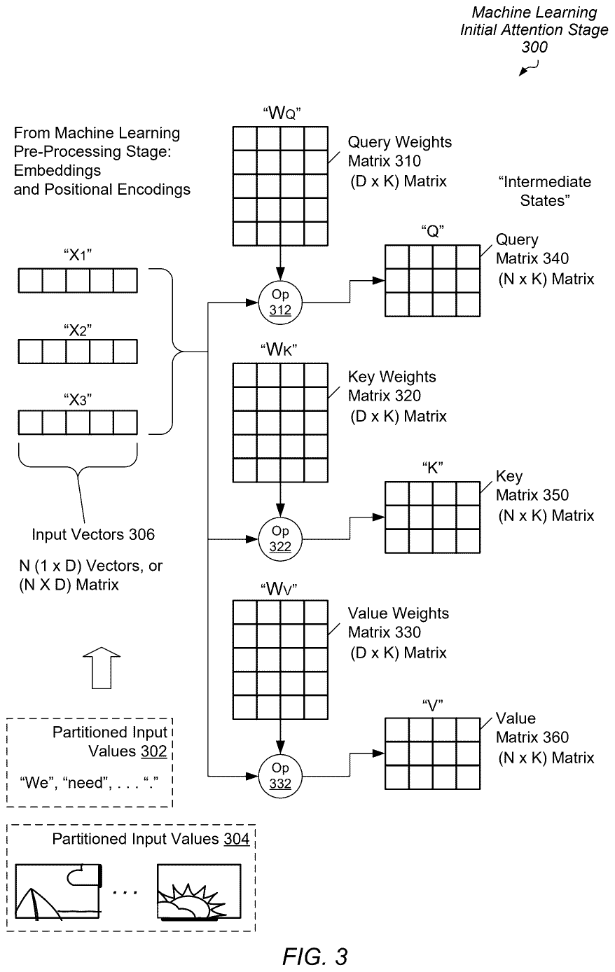

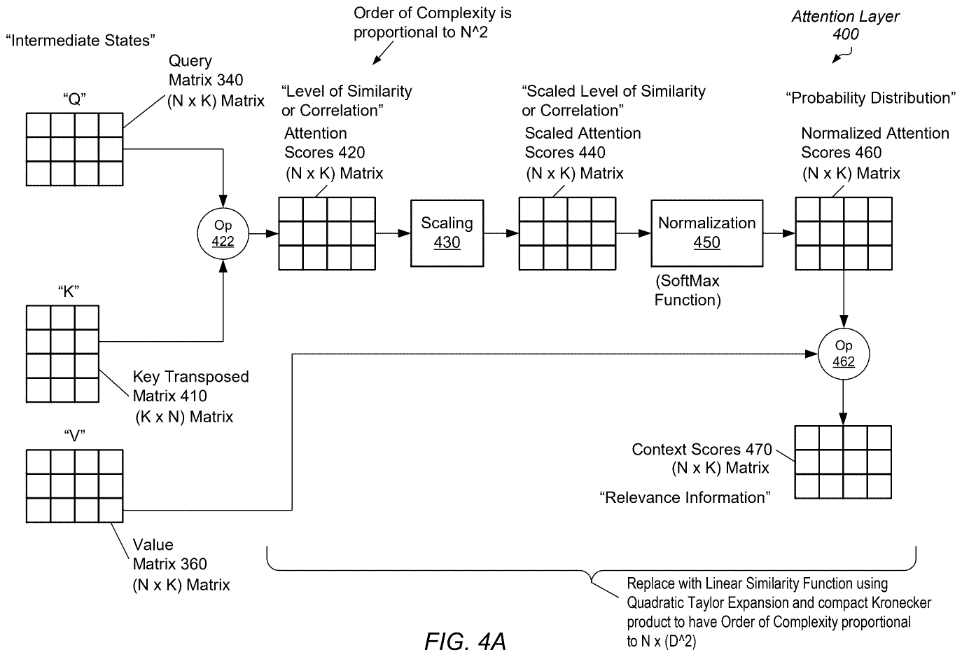

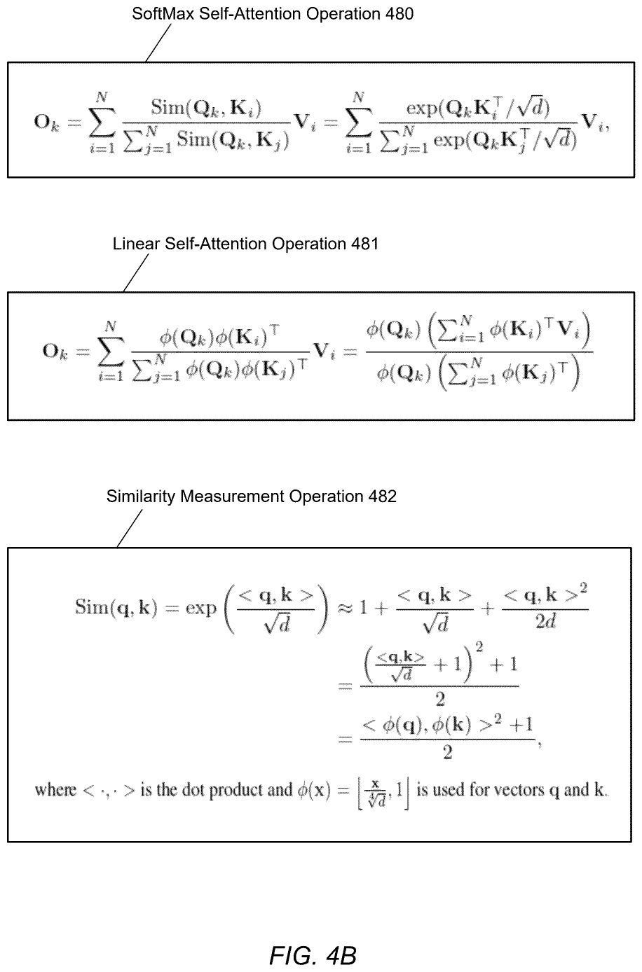

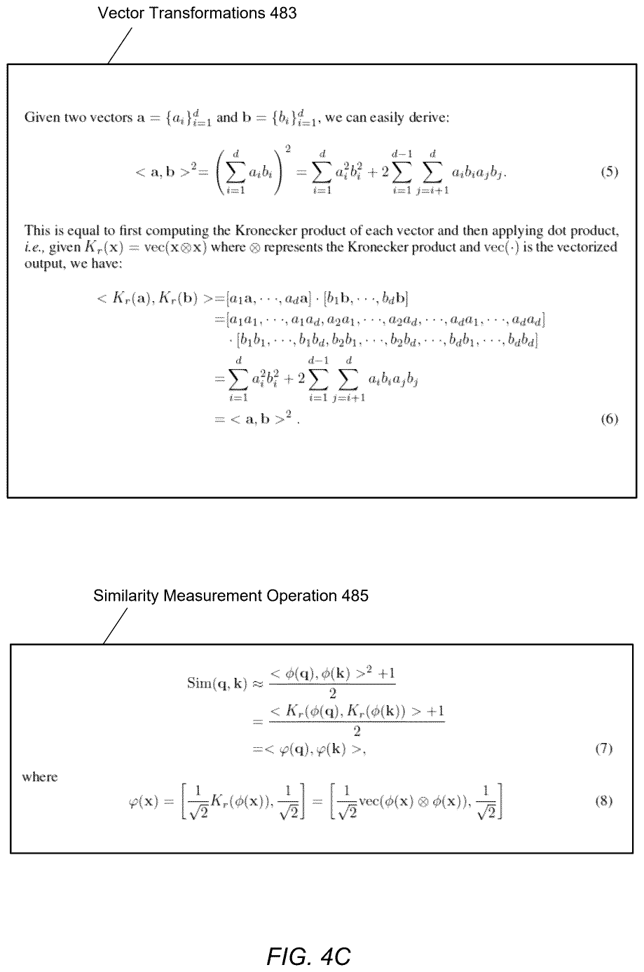

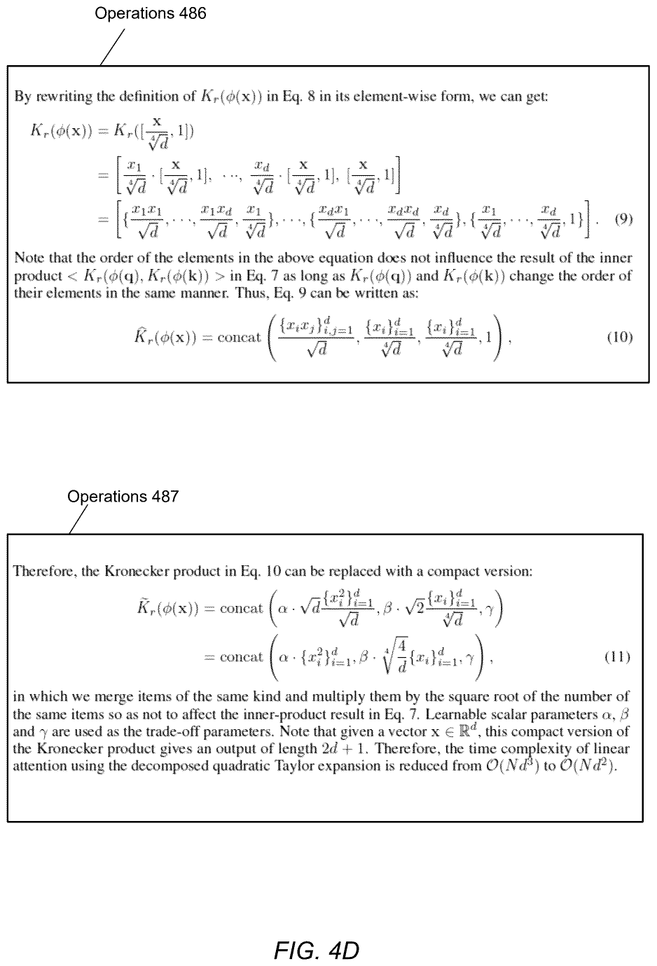

In various implementations, image 110 is divided into multiple, equal-sized, non-overlapping patches such as patches 112-116. As further described in machine learning (ML) model 200 (of FIG. 2), machine learning model weights are used to generate the input vectors 130 from the patches 112-116. Transformer stage (or model or block or layer) 140 (and any additional transformer stages) utilizes attention and self-attention mathematical techniques to track similarities and correlations, such as dependencies or relationships, among different elements of input values such as patches 112-116 and values of a database of objects. To track the dependencies and relationships, transformer stage 140 utilizes linear attention layer 142. Typically, an attention layer has a latency based on a time complexity proportional to (N²×d) where N is the number of input values and N is a positive, non-zero integer. The value “d” (or “D”) is the dimension of input vectors 130 representing patches 112-116 and the dimension specifies the number of numerical values (integers or floating-point values) used in each of the input vectors 130. For example, if there are 9 patches (N=9) in patches 112-116, and there are 5 numerical values in each of input vectors 130 (d=5), then the latency is proportional to the time complexity equal to (N²×d)=(9²×5)=405. In contrast to the typical attention layer, linear attention layer 142 has a latency that is proportional to the time complexity equal to (N×d²)=(9×5²)=225. Since the patch dimension d is always smaller than (less than) the number of patches N in the architectures of vision transformers (ViT) and other types of large language models (LLMs) relying on transformer stages, the computation overhead is reduced by using linear attention layer 142. Further details of the computations are provided in the description of initial stage 300 (of FIG. 3), attention layer 400 (of FIG. 4A), and operations and equations of FIGS. 4B-4D.

Many attempts have been made to generate a linear attention layer that has a latency proportional to the number of input values (N) and not proportional to the quadratic of the number of input values (N²). However, many of these techniques reduce accuracy to a level below an acceptable threshold and then retraining of the ML model is required. In contrast to these techniques, linear attention layer 142 provides reduced complexity of self-attention techniques without sacrificing accuracy. As used herein, the “similarity measurement function” is the exponential of the scaled dot product of the ML query vector and the transpose of the ML key vector. In other words, Sim(Qₖ, Kᵢ)=exp (QₖK^{T}ᵢ/\sqrt{d}) is the similarity measurement function where the terms Qₖ and Kᵢ (Kⱼ) are the corresponding k-th and i-th (j-th) row vectors of the query and key matrices, respectively. These matrices and the similarity measurement function are further described in the description of initial stage 300 (of FIG. 3), attention layer 400 (of FIG. 4A), and operations and equations of FIGS. 4B-4D such as the SoftMax self-attention operation 480. As further described in the description of FIGS. 4B-4D, linear attention layer 142 approximates the similarity measurement function by utilizing the quadratic Taylor expansion of the similarity measurement function. At this point, the quadratic relationship with the number of input patches 112-116 (N) still exists. Using the mathematical Kronecker product, the approximation is transformed into a dot product of two embedding vectors. Each of the embedding vectors utilizes the Kronecker product of a transformed version (linear transformation) of the original query vector and key vector.

Next, expanding the Kronecker product in its element-wise form and grouping similar terms does not alter the overall dot product as long as the same steps are applied to each of the query vector and the key vector being used in the dot product. Following, using the self-multiplication terms to represent all quadratic terms allows the Kronecker product to be represented with a compact version (compact Kronecker product). Again, when the same mathematical steps are applied to both vectors (transformed query vector and transformed key vector), the result of the dot product is not changed. Therefore, grouping (merging) items (or elements) with the same denominator and multiplying them by the square root of the number of elements in a group does not affect the overall dot product. Doing so, though, reduces the length of the output of the compact Kronecker product to 2D+1 where D is the size of the dimension of the input vectors 130. Therefore, the dot product of the linear attention layer 142 has a latency proportional to N and the square of D such as (N×d²).

Referring to FIG. 2, a generalized diagram is shown of a machine learning model 200 that performs efficient execution of repetitive operations of a machine learning model. As shown, machine learning model 200 includes data pre-processing stage 220 and transformer stage (or model or layer) 260. In some implementations, machine learning model 200 includes one or more additional transformer stages such as at least transformer stage 270, which is shown in a dashed box since it is optional and can include more than one transformer stage. Data pre-processing stage 220 receives input values 210 and generates input vectors 230, which are sent to transformer stage 260. Transformer stage 260 (and any additional transformer stages 270) uses input vectors 230 to generate output values 280.

By using transformer stages (or models or layers) 260 (and any additional transformer stages 270), machine learning model 200 uses a neural network structure to generate output values 280 from input values 210 based on at least self-attention techniques that track relationships and relevance between elements of an input sequence (input values 210) and tracking long term dependencies or relationships with prior input values 210. Transformer stage (or model or layer) 260 (and any additional transformer stages 270) utilizes attention and self-attention mathematical techniques to track dependencies or relationships among elements of the input values 210 and previous input values. In various implementations, machine learning model 200 is a large language model (LLM), which includes multiple transformer stages relying on self-attention mathematical techniques for processing natural language processing (NLP) applications.

The NLP applications generate content such as answers to questions or paragraphs of an article, provide language translations of sentences and phrases, generate predictions and/or recommendations of search queries, generate classifications of input images, generate images and video frames based on user input, and so forth. Examples of input values 210 are also shown in FIG. 3 as partitioned input values 302, which includes text inputs and punctuation marks of a user query, and partitioned input values 304, which are patches of an input image. Multiple other examples of input values 210 and output values 280 are also possible and contemplated. Examples of LLMs are Generative Pre-trained Transformer 4 (GPT-4) developed by OpenAI, Inc., Large Language Model Meta AI (Llama or LLaMA) developed by Meta AI, Orca developed by Microsoft Corp., Mistral 7B developed by Mistral AI, Stable Diffusion developed by Stability AI, and so forth. Other examples of LLMs are a variety of types of vision transformers (ViT) such as LLMs that utilize Cross-Shaped Window (CSWin) transformer blocks, LLMs that rely on Cross-Attention Multi-Scale Vision Transformer (CrossViT) blocks, LLMs that rely on Data-Efficient Image Transformer (DEIT) blocks, and so forth.

In some implementations, input values 210 are values of a user query that includes a user identifier (ID) and a movie title, a music song title or other item for purchasing or searching that has a corresponding item ID, and the output values 280 include a selection (mouse click) probability on another movie title, song title or other similar item on a web page. In other implementations, input values 210 are input text from a user for a natural language processing (NLP) application. The type of NLP application determines the type of output values 280 generated by transformer stage 260 (and any additional transformer stages 270). The NLP applications can include language translation services, virtual assistants, chatbots, and so forth. In yet other implementations, the input values 210 are patches or subsets of a video frame or an image and the output value 280 is a classification or identifying category of the entire image or multiple classifications of multiple objects in the image. As described earlier, examples of input values 210 are patches 112-116 (of FIG. 1) and partitioned input values 302 (of FIG. 3), which includes text inputs and punctuation marks of a user query, and partitioned input values 304, which are patches of an input image. Multiple other examples of input values 210 and output values 280 are also possible and contemplated.

Embedding layer 222 of data pre-processing stage 220 converts each input value (or token) of input values 210 to a multi-dimension embedding (embedding vector). In an implementation, the input values 210 includes the sentence “We need coffee.” Each element (word or token or punctuation mark) of the input sequence (sentence that represents input values 210) is converted to a D-dimension embedding vector such as a vector with “D” floating-point numbers where “D” is a positive, non-zero integer. In a simplified implementation, D is 4 and the embedding layer 222 converts the word “coffee” of input values 210 to the 4-dimensional vector (or embedding) equal to [0.674, 0.002, −0.395, 0.983]. Embedding layer 222 performs a similar conversion (mapping) for the other elements (or tokens) “We” and “need” and the punctuation period “.” of the input sequence (input values 210).

In the above example, dimension D is kept small for illustrative purposes. However, in other implementations, another value for dimension D is used based on design requirements. For example, dimension D can be 16, and embedding layer 222 converts the word “coffee” of input values 210 to a 16-dimensional vector (or embedding vector) that includes 16 floating-point numbers. Dimension D can also be 512, and embedding layer 222 converts the word “coffee” of input values 210 to a 512-dimensional vector (or embedding vector) that includes 512 floating-point numbers. In yet other implementations, input values 210 includes three non-overlapping patches or subsets of an image or video frame and embedding layer 222 converts each of the three patches to a D-dimensional vector (or embedding vector). In another example, the image or video frame can be divided into nine respective, non-overlapping and equal-sized patches. When D is 256, the patch that is the top right corner of the image or video frame is converted into an embedding vector with 256 floating-point numbers. Similarly, each of the other eight patches of the total nine patches is converted to a corresponding and unique 256-dimension embedding vector.

Lower dimensional linear embeddings 224 (or embeddings 224) represent the D-dimension vectors (embedding vectors) generated by embedding layer 222. These embeddings 224 are D-dimension numerical representations, which are also referred to as “embedding vectors.” As used herein, each element or individual input value of input values 210 can be referred to as a “token.” In some implementations, each element (or token) of input values 210 is converted into a D-dimension embedding vector by a lookup operation of an embedding table. To generate a D-dimension embedding vector for each of the tokens of input values 210, in some implementations, a variety of mapping techniques can be used to map the embeddings 224 tokens to “latent space vectors” or “latent vectors” or “embedding rows.” Tokenization and mapping cause the original data of input values 210 to be mapped from a higher-dimensional space to a lower-dimensional space while preserving the meaning of the original data. Examples of these other mapping techniques are the Principal Component Analysis (PCA) technique, the Singular Value Decomposition (SVD) technique, the Word2Vec technique, the t-SNE (t-Distributed Stochastic Neighbor Embedding) technique, the UMAP (Uniform Manifold Approximation and Projection) technique, and so forth.

Data pre-processing stage 220 also includes positional encoding 226. Positional encoding layer 226 maps a position of an element of an input sequence, such as input values 210, to a vector of numerical representations. For example, when input values 210 is a sequence of ten textual words or a sequence of ten patches of an image, positional encoding layer 226 provides a unique vector with “D” numerical representations for each of the ten positions within the sequence. Therefore, by using the vectors, positional encoding 226 identifies which textual word or patch is the first element in the sequence of input values 210, identifies which textual word or patch is the second element in the sequence, identifies which textual word or patch is the third element in the sequence, and so on. Positional encoding layer 226 does not use a single numerical value, such as a positional index, for each element of the input sequence since the input sequence can be large and the resulting magnitudes of the indices would be large. The large magnitude would cause the indices to consume a large amount of data storage of the hardware resources of the computing system.

In some implementations, positional encoding layer 226 utilizes one or more of the trigonometric sine function and the trigonometric cosine function to generate the unique numerical representations (positional encoding vectors) to place in the vectors that specify the positional encodings. The frequencies of the selected trigonometric function (sine or cosine) can be set to depend on one or more of the dimension of the embeddings 224, the position of the element in the input sequence (input values 210), the position of the numerical representation within the vector of the element, user-defined values, and so forth. In other implementations, a variety of other functions and methods are used to generate the positional encoding vectors. To generate the input vectors 230, positional encoding layer 226 combines the embedding layer 222 with the positional encoding vectors. In an implementation, for each element of the input sequence (input values 210), positional encoding layer 226 sums each numerical representation in the embedding layer 222 with a corresponding numerical representation of the positional encoding vectors. In other implementations, positional encoding layer 226 combines the embedding layer 222 with the positional encoding vectors using a variety of other mathematical computations.

Transformer stage (or model or layer) 260 receives the input vectors 230 from the data pre-processing stage 230. Transformer stage 260 also receives the projection (learnable) weights 232, which are machine learning weights. Transformer stage 260 generates output values, which are used as outputs of machine learning model 200, such as output values 280, or used as inputs to a subsequent transformer stage such as transformer stage 270. Unlike a recurrent neural network (RNN), such as a long short term memory (LSTM) neural network, and other types of neural networks that are sequential machine learning models relying on recurrence and relationships of nearby elements of an input sequence (input values 210), transformer stage 260 provides parallel processing relying on relationships concurrently across all elements of the input sequence. For example, positional encoding layer 226 provided the relationships in the form of positional encoded vectors to be used by transformer stage 260. These positional encoded vectors were combined with the embeddings 224 to generate the input vectors 230.

As described earlier, transformer stages 260 (and 270) utilize self-attention mathematical techniques. These techniques numerically characterize relationships, dependencies and relevance between tokens of the input values 210. These techniques provide context information among the tokens. For example, the token “store” in a sentence or phrase can be a noun such as a physical building or online website where customers shop for items. The token “store” can also be a verb for holding an item in a location for later use. The context and relationships among other tokens provide the actual meaning of the token “store.” To provide the attention mathematical techniques that include relevance and context information, transformer stage 260 utilizes the projection (learnable) weights 232 (or weights 232). A further description of weights 232 is provided in the description of machine learning initial stage 300 of FIG. 3.

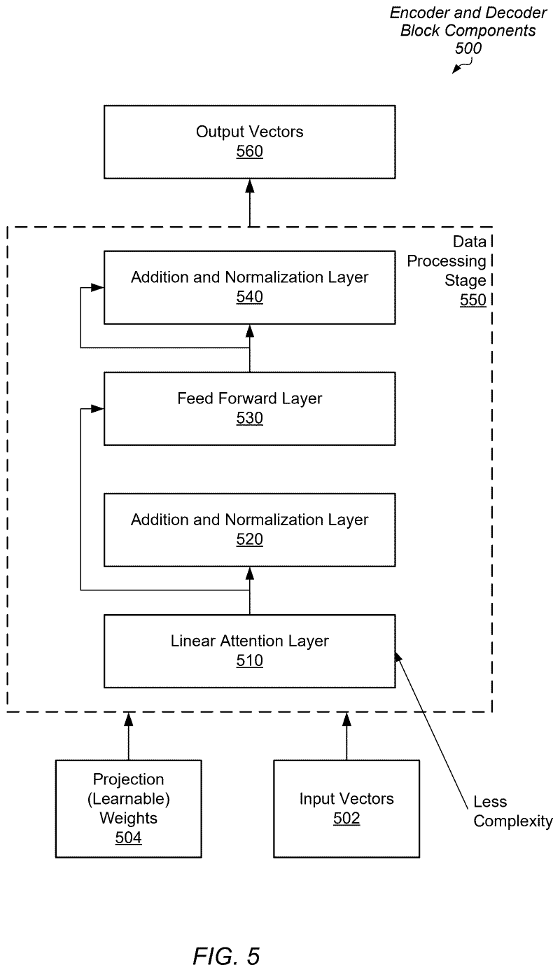

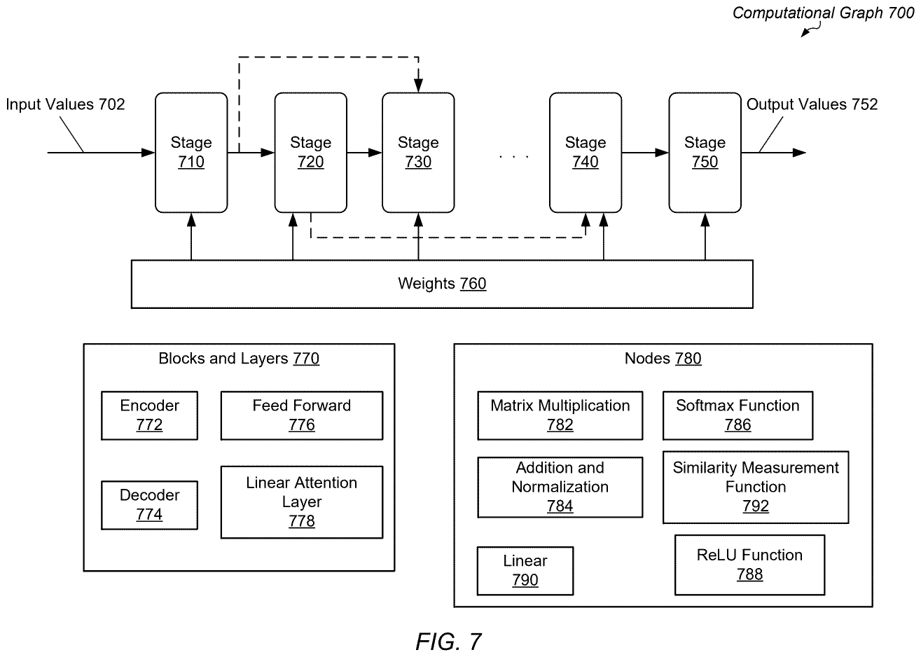

Transformer stage 260 includes one or more encoder blocks, such as encoder block 240 and 242, and one or more decoder blocks, such as decoder block 250 and 252. In various implementations, components of the encoder blocks 240 and 242 and the decoder blocks 250 and 252 are similar. For example, as illustrated in encoder and decoder block components 500 of FIG. 5, encoder and decoder block components can include an attention layer, one or more addition and normalization layers, and a feed forward layer. These layers receive input vectors and generate output vectors. The number and arrangement of the layers is based on a computational graph, such as computational graph 700 of FIG. 7, set up by designers of the machine learning model.

Referring to FIG. 3, a generalized diagram is shown of a machine learning initial attention stage 300 that performs efficient execution of repetitive operations of a machine learning model. As shown, machine learning initial attention stage 300 (or stage 300) receives input vectors 306 and generates the intermediate states that include the matrices 340, 350 and 360. In various implementations, an embedding layer (not shown), such as embedding layer 222 of data pre-processing stage 220 (of FIG. 2), converts each input value (or token) of partitioned input values 302 or 304 to a multi-dimension embedding (embedding vector) such as one of input vectors 306. Partitioned input values 302 includes text inputs and punctuation marks of a user query. Partitioned input values 304 are patches of an input image. Although shown together, stage 300 utilizes one of the partitioned input values 302 and 304 to generate a particular set of the intermediate states that include the matrices 340, 350 and 360. The partitioned input values 302 and 304 are not mixed together.

As shown, partitioned input values 302 includes text words and punctuation marks of a user query such as a sentence, phrase or question. Each element (word or token or punctuation mark) of the user query is converted to a D-dimension embedding vector such as a vector with “D” floating-point numbers where “D” is a positive, non-zero integer. One of the input vectors 306 represents this D-dimension embedding vector in a simplified implementation. For example, the embedding layer converts the token “We” to the D-dimension embedding vector “X₁” of input vectors 306, converts the token “need” to the D-dimension embedding vector “X₂” of input vectors 306, and so forth. In another implementation, embedding layer converts the token that is a patch or subset of a video frame or still image to the D-dimension embedding vector “X₁” of input vectors 306, converts a second patch to the D-dimension embedding vector “X₂” of input vectors 306, and so forth. A positional encoding layer (not shown), such as positional encoding layer 226 of FIG. 2, combines the embedding vectors with corresponding positional encoding vectors to generate the final numerical representations of input vectors 306. Although three input vectors of input vectors 306 are shown, in various implementations, another number of input vectors is used based on design requirements.

The circuitry (not shown) of stage 300 receives the input vectors 306 and receives the projection (learnable) weights 310, 320 and 330, which are machine learning model weights. The circuitry (not shown) of stage 300 generates the intermediate states that include the matrices 340, 350 and 360. As described earlier, transformer stages utilize self-attention mathematical techniques. These techniques numerically characterize relationships, dependencies and relevance between tokens of the input values and tokens of a database to provide probabilities of correct responses or generative content. These techniques provide context information among the tokens. For example, the token “right” in a sentence or phrase can indicate a direction, which is the opposite of “left,” or it can indicate whether a response is correct or incorrect. The context and relationships among other tokens provide the actual meaning of the token “right.” To provide the attention mathematical techniques, stage 300 utilizes the query weights matrix 310, the key weights matrix 320, and the value weights matrix 330.

In various implementations, the circuitry of stage 300 combines the input vectors 306 into a matrix. The circuitry of operator 312 (“Op” 312) performs matrix multiplication using the query weights matrix 310 and the matrix that includes input vectors 306. Each of the input vectors 306 is a (1×D) vector, and when N vectors are placed together in a matrix, the result is an N×D matrix. The query weights matrix 310 is a (D×K) matrix, and the resulting query matrix 340 is an (N×K) matrix. Here, N, D and K are positive, non-zero integers. Similarly, to generate the key matrix 350, operator 322 performs matrix multiplication using the key weights matrix 320 and the matrix that includes input vectors 306. To generate the values matrix 360, operator 332 performs matrix multiplication using the values weights matrix 330 and the matrix that includes input vectors 306.

Referring to FIG. 4A, a generalized diagram is shown of an attention layer 400 of a machine learning model. Although a particular set of operations and an order of operations is shown, it is understood that in other implementations a variety of other steps and orders can be used to provide context scores 470 to a subsequent stage of data processing to indicate an amount of relevance or similarity among received input values. For example, in other implementations, techniques directed to Flash Attention and Paged Attention can be used. As shown, attention layer 400 receives intermediate states and generates the context scores 470. The order of complexity of attention layer 400 is proportional to N² based on at least the circuitry of the operator 422 performing a dot product using matrices 340 and 410 to generate the attention scores 420. In various implementations, the intermediate states include the query matrix 340 and value matrix 360 (of FIG. 3) and the key transposed matrix 410, which is a transpose of the key matrix 350 (of FIG. 3). The circuitry of the operator 422 performs a dot product of matrices 340 and 410 to generate the attention scores 420. With the query matrix 340 being an (N×K) matrix and the matrix 410 being a (K×N) matrix, the attention scores 420 is an (N×K) matrix. The attention scores 420 provides a numerical representation of the similarities between the query matrix 340 and the key transposed matrix 410. The scaling block 430 multiples each matrix element of the attention scores 420 by a scaling factor to generate the scaled attention scores 440, which includes an (N×K) matrix. Scaling block 430 performs scaling to stabilize the attention layer 400. The multiplication of the matrix elements can lead to very large data values, so the matrix elements are reduced by a scaling factor. In some implementations, the scaling factor is the inverse of the square root of dimension D. Therefore, each of the matrix elements of the matrix of the attention scores 420 is divided by the square root of dimension D.

To generate the normalized attention scores 460, the normalization block 450 performs a normalization operation on the scaled attention scores 440. The resulting (N×K) matrix of the normalized attention scores 460 includes each matrix element with a floating-point value between 0 and 1. In various implementations, each row of the resulting (N×K) matrix of the normalized attention scores 460 sums to 1. In some implementations, the normalization operation provides a higher emphasis on higher scaled attention scores and provides a lower emphasis on lower scaled attention scores. Normalization block 450 determines which tokens of an input sequence (input values) should receive more attention for a particular input token. Normalization block 450 generates numerical representations of the relevance of tokens between themselves. When using the normalization block 450, larger scaled attention scores of the scaled attention scores 440 correspond to larger probabilities in the input components will correspond to larger probabilities in the normalized attention scores 460.

In various implementations, normalization block 450 uses the SoftMax function (or SoftMax function) to perform the normalization operation. For a particular matrix element of a first row of the scaled attention scores 440, the SoftMax function (or softargmax function or normalized exponential function) uses the exponential operation on the matrix element and normalizes the resulting value by dividing the resulting value by the sum of the resulting values of the entire vector. For example, if a vector (row of a matrix) includes the values [0.24, −3.7, 4.3], then the exponentials of each of the elements is [1.27, 0.0247, 73.70]. The sum is (1.27+0.0247+73.70) or 74.99. The SoftMax function result for the first element of the vector is (1.27/74.99) or 0.0169. The SoftMax function result for the vector is [0.0169, 0.000329, 0.983]. These operations are performed for each row (vector) of the scaled attention scores 440 to generate the matrix of the normalized attention scores 560. Afterward, the operator 462 performs matrix multiplication using the matrix of the normalized attention scores 460 and the value matrix 960. The result is the matrix of the context scores 470.

Attention layer 400 has a latency based on a time complexity proportional to (N²×d). For example, if there are 9 input values (N=9), and the dimension d includes 5 numerical values (d=5) in each of the input vectors representing the input values, then the latency is proportional to the time complexity equal to (N²×d)=(9²×5)=405. In contrast to attention layer 400, linear attention layer 142 (of FIG. 1) utilizes the operations and equations of FIGS. 4B-4D, and accordingly, has a latency that is proportional to the time complexity equal to (N×d²). With N being 9 and d being 5, the latency is equal to (N×d²)=(9×5²)=225. Since the patch dimension d is always smaller than (less than) the number of patches N in the architectures of vision transformers (ViT) and other types of large language models (LLMs) relying on transformer stages, the computation overhead is reduced by using linear attention layer 142. Further details of the computations are provided in the description of operations and equations of FIGS. 4B-4D.

Referring to FIG. 4B, a generalized diagram is shown of operations of a machine learning model. The SoftMax self-attention operation 480 summarizes mathematically the steps performed by the normalization block 450 (of FIG. 4A). Here, the symbols Q, K and V represent the intermediate states that include the query matrix 340, the key matrix 350 and the value matrix 360. The terms Qₖ, Kᵢ (Kⱼ), Vi, Ok are the corresponding k-th, i-th (j-th), i-th, and k-th row vectors of the query, key, value and output matrices, respectively. As shown earlier for attention scores 420 (of FIG. 4A), the inner product of the query-key pair is first computed to calculate the similarity between the pair, then a scale is applied for stability and a SoftMax function is used to transfer the similarity into probability. This probability is applied to the value matrix to get the final attention score output. The SoftMax attention computes the inner products of all the query-key pairs and results in an O(N²d) time complexity. Here, N is the number of patches, such as patches 112-116 (of FIG. 1), and d is the dimension previously described as D. Each of N and d is a positive, non-zero integer. Here, Sim (Qₖ, Kᵢ)=exp (QₖK^{T}ᵢ/\sqrt{d}) is the similarity measurement function in the SoftMax self-attention operation 480.

The overhead of the computation of the SoftMax self-attention operation 480 mainly comes from the matrix multiplication. By decomposing the similarity measurement function into two separate kernel embeddings, i.e., Sim (Qₖ, Kᵢ)=φ(Qₖ)φ(Kᵢ)^{T}, and the original SoftMax self-attention operation 480 can be changed into linear attention by exchanging the order of matrix multiplication, which provides Linear Self-Attention Operation 481. Here, the complexity is changed from O(N²d) to O(Nd²). Since the patch dimension d is always smaller than the number of patches N in the architectures of vision transformers (ViT), the computation overhead can be reduced. The quadratic Taylor expansion of the similarity measurement function is expressed as the Similarity Measurement Operation 482. Continuing with operations in FIG. 4C, vector transformations 483 include performing a quadratic Taylor expansion of the SoftMax self-attention operation 480 being performed on vectors and utilizing the Kronecker product on each of the vectors. Applying equation (6) of vector transformations 483 to the output formula of Similarity Measurement Operation 482 followed by decomposing the similarity function to generate the operations in Similarity Measurement Operation 485.

The time complexity of linear attention using the decomposed quadratic Taylor expansion is O(Nd³) in the Similarity Measurement Operation 485. Compared to the original SoftMax attention with O(N²d) time complexity, the output formula in Similarity Measurement Operation 485 does not reduce the time complexity. Continuing with operations in FIG. 4D, operations 486 provide a fast approximation algorithm to accelerate the computation of the Kronecker product and reduce the computational complexity. Equation (9) of operations 486 rewrites the Kronecker product from equation (8) of Similarity Measurement Operation 485 in its element-wise form. Equation (10) of operations 486 is equation (9) rewritten with similar terms grouped together. The first term is the quadratic term that contains d² components representing the multiplication of each pair of elements in vector x (including self-multiplication).

The second term and the third term of equation (10) of operations 486 are the linear term with length d each, and the fourth term is the constant term. Since the computational load of the inner product in equation (10) of operations 486 mainly comes from the quadratic term, it is important to reduce the number of elements in this term. Randomly preserving d items from d² elements is an efficient approach but leads to poor results. A grouping technique selects the self-multiplication terms {x²ᵢ} from i=1 to d to represent all of the quadratic terms. Therefore, the Kronecker product in equation (10) of operations 486 can be replaced with a compact version shown in equation (11) of operations 487. Terms of the same kind are merged together and multiplied by the square root of the number of the same items so as not to affect the inner-product result in equation (7) of Similarity Measurement Operation 485. Learnable scalar parameters a, B and y are used as the trade-off parameters. These scalar parameters are used to increase the accuracy achieved by the linear attention layer utilizing an approximation relying on the quadratic Taylor expansion and the compact Kronecker product. This compact version of the Kronecker product provides an output of length 2d+1. Therefore, the time complexity of linear attention using the decomposed quadratic Taylor expansion is reduced from O(Nd³) to O(Nd²).

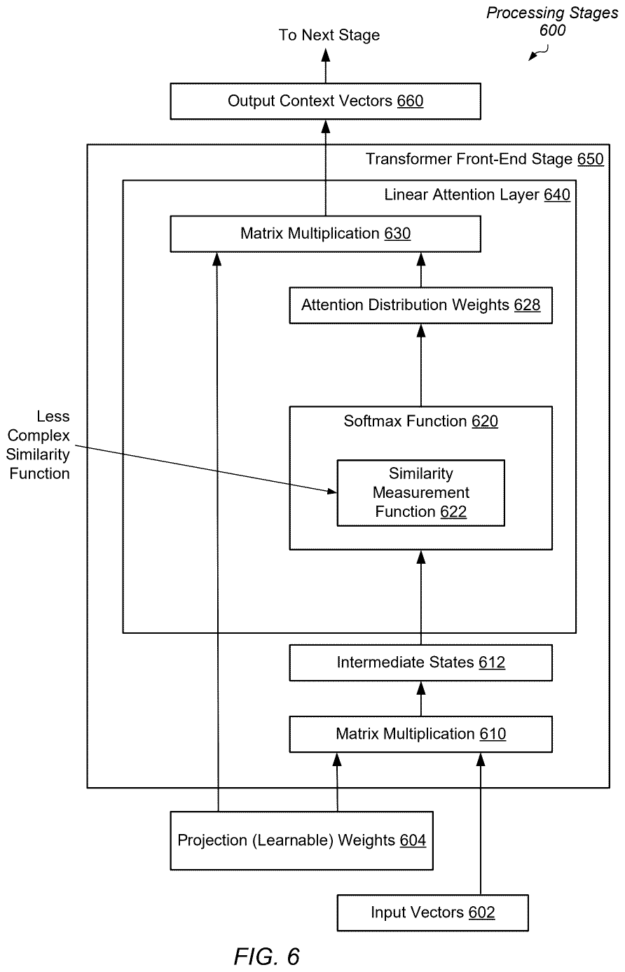

Turning now to FIG. 5, a generalized diagram is shown of encoder and decoder block components 500 of a machine learning model. As shown, encoder and decoder block components 500 (or components 500) receive input vectors 502 and generate output vectors 560 using the data processing stage 550 (or stage 550). In some implementations, stage 550 includes a linear attention layer 510, one or more addition and normalization layers, such as layers 510 and 540, and a feed forward layer 530. Linear attention layer 510 generates numerical representations of the relevance of tokens between themselves. Further steps to do this operation are provided in the description of the machine learning initial stage 300 (of FIG. 3), the operations and equations of FIGS. 4B-4D, and the similarity function 640 (of FIG. 6). The addition and normalization layers 520 and 540 combine values of vectors (rows of matrices) by summing them in some implementations and normalizing them, if necessary. The summation provides a residual connection. Normalization allows output values to not become too large, which allows more layers to be used in the machine learning model.

Feed forward layer 530 typically includes a rectified linear unit (ReLU) layer between two linear layers. The feed forward layer 530 utilizes a multilayer perceptron (MLP) to implement its steps that include feed-forward data movement in hidden layers with no loops. In various implementations, each of the linear layers includes its own set of weights (query weight matrix, key weight matrix, value weight matrix) and performs the steps described for machine learning initial attention stage 300 (of FIG. 3). Therefore, the number of weights can increase considerably, especially when the number of layers increase and the number of encoder blocks and decoder blocks increase. As described earlier, the transformer stage 260 (of FIG. 2) can have any number of encoder blocks 240 and 242 and any number of decoder blocks 250 and 252. In an implementation, there are 6 of each of the encoder blocks and decoder blocks. The inputs to the decoder blocks can originate from the outputs of one or more encoder blocks and one or more decoder blocks. Therefore, the attention techniques are repeated and are based on different layers of the transformer model (or stage or layer). The order of operations and the inputs used for different layers and sub-layers are described in a computational graph such as computational graph 700 (of FIG. 7).

Turning now to FIG. 6, a generalized diagram is shown of processing stages 600 of a transformer of a machine learning model. Similar to ML model 200 (of FIG. 2), stage 300 (of FIG. 3), attention layer 400 (of FIG. 4), and components 500 (of FIG. 5), although a particular set of operations and blocks are shown and an order of operations is shown, it is understood that in other implementations a variety of other steps and orders can be used to provide output values to a subsequent stage of data processing. As shown, processing stages 600 includes transformer front-end stage 650 that receives input vectors 602 and the projection (learnable) weights 604 (or weights 604) and generates output context vectors 660. The transformer front-end stage 650 (or stage 650) includes linear attention layer 640, which receives the intermediate states 612 and weights 604 and generates the output context vectors 660. In various implementations, the input vectors 602 have the format and functionality of input vectors 230 (of FIG. 2), input vectors 306 (of FIG. 3) and input vectors 502 (of FIG. 5). The weights 604 have the format and functionality of weights 962 (of FIG. 2), weight matrices 310, 320 and 330 (of FIG. 3) and weights 504 (of FIG. 5).

During a training phase of the large language model (LLM), multiple initial values of weights and thresholds are input into the LLM, which is executed with multiple iterations until results are determined to be correct above a threshold number of times. Examples of these LLMs include the examples of LLMs described earlier for ML model 200 (of FIG. 2). The training process is an iterative process that generates a set of weight values used for mapping the input data received to the output results. The weights can be optimized for a particular system architecture of a computing device. In some implementations, the training process utilizes unsupervised learning where input data values are provided with no label (expected result). In other implementations, at least a portion of the training process is supervised and includes labels.

In various implementations, stage 650 includes circuitry that performs the operations illustrated in stage 300 (of FIG. 3) and operations and equations of FIGS. 4B-4D to implement linear attention layer 640. Matrix multiplication block 610 performs matrix multiplication of input vectors 602 arranged as a matrix and particular matrices of weights 604. In some implementations, matrix multiplication block 610 performs the steps shown in stage 300 (of FIG. 3) to generate the intermediate states 612, which have the format and functionality of the intermediate states shown in stage 300 (of FIG. 3), attention layer 400 (of FIG. 4A) and operations of FIG. 4B. To generate the attention distribution weights 628, the SoftMax function block 620 performs the operations of FIGS. 4B-4D. Similarity measurement function 622 performs the operations of Sim (Qₖ, Kᵢ)=exp (QₖK^{T}ᵢ/\sqrt{d}) as shown in the SoftMax self-attention operation 480 (of FIG. 4B) by approximating it with the quadratic Taylor expansion, decomposing the approximation using the Kronecker product, and replacing the Kronecker product with a compact Kronecker product. These steps are shown in operations and equations of FIGS. 4B-4D. The matrix multiplication block 630 performs matrix multiplication of the matrix of the attention distribution weights 628 and the values matrix of weights 604. This is a similar operation performed by operator 462 (of FIG. 4). The resulting output context vectors 660 are sent as an output to the next stage of a large langue model (LLM) or as the final results of the LLM. The resulting output context vectors 660 are sent as an output to the next stage of a large language model (LLM) or as the final results of the LLM.

Turning now to FIG. 7, a generalized diagram is shown of a computational graph 700 of a machine learning model. As shown, computational graph 700 includes multiple stages 710-750 that receives the input values 702 and generates the output values 752. The input values 702 have the format and functionality of input values 210 (of FIG. 2) and the output values 752 have the format and functionality of output values 280 (of FIG. 2). Each of the stages 710-750 includes one or more of the blocks and layers 760 and the nodes 780. The computational graph 700 is a graph that visually represents the computational order of operations to perform to implement a machine learning model, the types of operations to perform, and the data dependencies between the operations to perform. In an implementation, the hierarchy of the computational graph 700 has the stages at the highest level followed by blocks and layers and has the nodes at the lowest level. In other implementations, the terms “stage,” “block,” “layer,” and “node” are used differently to represent a different hierarchy. In computational graph 700, the solid arrows represent edges that indicate the data dependencies. The dashed arrows represent possible data dependencies, which are included in one representation of computational graph 700 but not in another implementation.

Although a particular number and type of stages, blocks, layers and nodes are shown, in other implementations, other types of these components and another number of these components are used, and different available versions of the components are possible and contemplated. The stages 710-750 include one or more of the components of the blocks and layers 760 and the nodes 780. In an implementation, some of the states 710-750 include the same functionality and subsets of multiple stages of stages 710-750 include the same functionality. However, different input values and different weights are processed. For example, the stages 710-750 receive corresponding weights of the machine learning weights 760 (or weights 760). The weights 760 are set during a training process.

In some implementations, the blocks and layers 770 include the encoder block 772, the decoder block 774, the feed forward layer 776 and the linear attention layer 778. In an implementation, these blocks have the same functionality described earlier for similar components of machine learning model 200 (of FIG. 2), the components 500 (of FIG. 5), and processing stages 600 (of FIG. 6). In an implementation, the nodes 780 include the matrix multiplication node 782, the addition and normalization node 784, the SoftMax function node 786, the rectified linear unit (ReLU) node 788, the linear node 790 and the similarity measurement function 792. Other examples of a non-linear node besides ReLU node 788 can include one of a variety of types of non-linear functions such as a Gaussian error linear unit (GELU) function, a Sigmoid function, a Swish gated linear unit (SwigLU) function, and so forth. The similarity measurement function 792 performs the operations of Sim (Qₖ, Kᵢ)=exp (QₖK^{T}ᵢ/\sqrt{d}) shown in the SoftMax self-attention operation 480 (of FIG. 4B) by approximating it with the quadratic Taylor expansion, decomposing the approximation using the Kronecker product, and replacing the Kronecker product with a compact Kronecker product. These steps are shown in operations and equations of FIGS. 4B-4D. Designers construct computational graph 700 to provide the functionality of the desired machine learning model such as at least machine learning model 200 (of FIG. 2).

In various implementations, the ML model is written by a developer in one of a variety of high-level programming languages such as Python, R, Julia, C, C++, C#, and Java and so on. Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call and the predefined module includes a directed acyclic graph (DAG) providing a sequence of execution steps of a non-recurring computation. The layers 770 and nodes 780 provide the predefined modules to use in stages 710-750. The execution nodes of the DAG represent the predefined modules providing the mathematical expressions or operations to perform. Similar to the solid and dashed lines between stages 710-750, within each of the stages 710-750, there are lines representing the data flow between the predefined modules. These lines are also referred to as edges, and the edges of the DAG between the execution nodes represent data dependencies. The imported ML libraries and predefined modules are used to create computational graph 700.

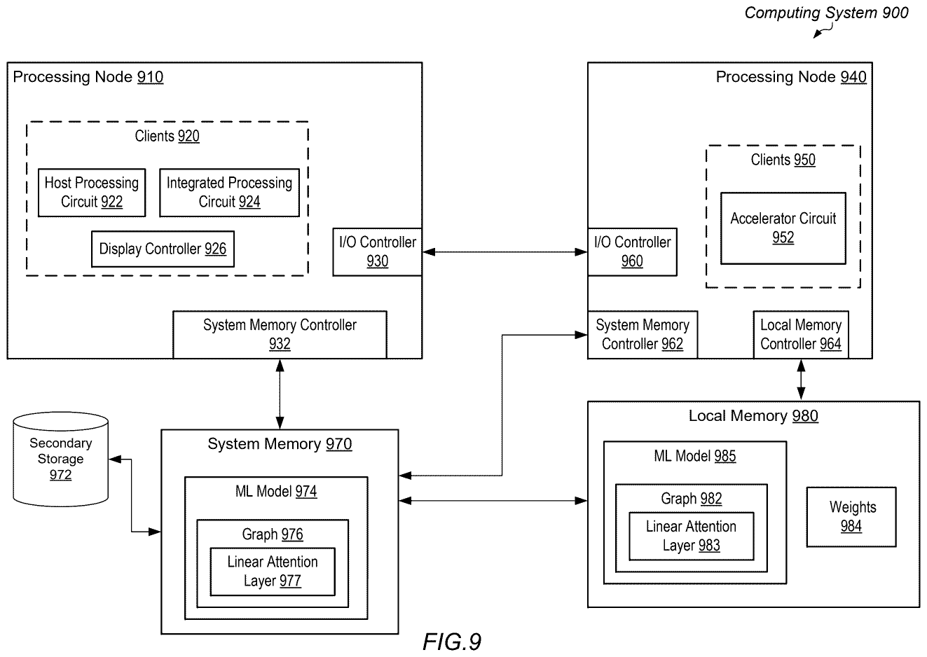

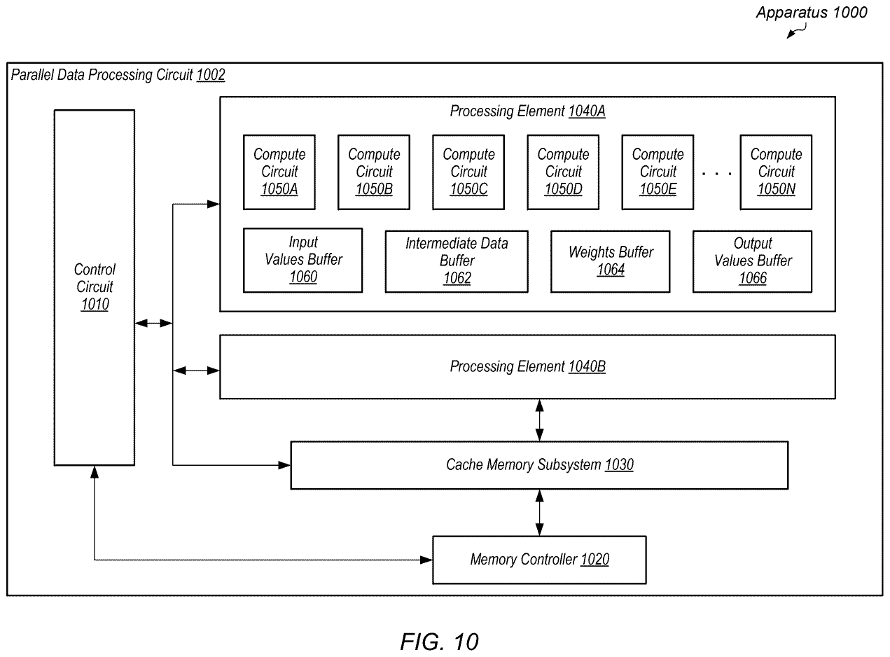

For the methods 800 and 1100, a computing system includes multiple processing circuits. Examples of the host processing circuit of the multiple processing circuits is host processing circuit 922 (of FIG. 9). Examples of the accelerator circuit of the multiple processing circuits are accelerator circuit 952 (of FIG. 9) and parallel data processing circuit 1002 (of FIG. 10). For the methods 800 and 1100, the multiple processing circuits execute a variety of types of parallel data applications such as a variety of types of machine learning (ML) models.

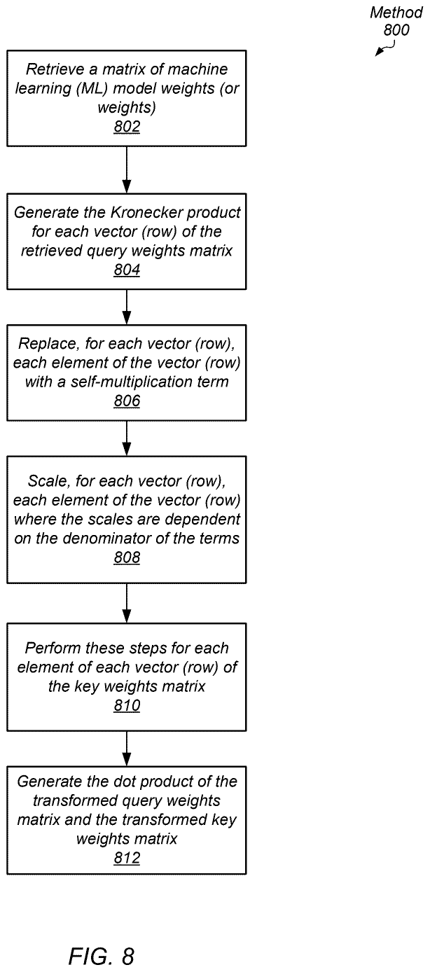

Referring to FIG. 8, a generalized diagram is shown of a method 800 for performing efficient execution of repetitive operations of a machine learning model. For purposes of discussion, the steps in this implementation are shown in sequential order. However, in other implementations some steps occur in a different order than shown, some steps are performed concurrently, some steps are combined with other steps, and some steps are absent.

In various implementations, machine learning model weights (or weights) have set values based on training of a corresponding machine learning model such as a large language model (LLM). Examples of these LLMs include the examples of LLMs described earlier for ML model 200 (of FIG. 2). During the training phase of the LLM, multiple initial values of weights and thresholds are input into the LLM, which is executed with multiple iterations until results are determined to be correct above a threshold number of times. The training process is an iterative process that generates the final values of the weights used during inference for mapping the input data received to output results. One of the multiple processing circuits of the computing system retrieves matrices of machine learning (ML) model weights (or weights) (block 802).

The processing circuit generates the Kronecker product for each vector (row) of the retrieved query weights matrix (block 804). The processing circuit replaces, for each vector (row), each element of the vector (row) with a self-multiplication term (block 806). The processing circuit scales, for each vector (row), each element of the vector (row) where the scales are dependent on the denominator of the terms (block 808). The processing circuit performs these steps for each element of each vector (row) of the key weights matrix (block 810). The processing circuit generates the dot product of the transformed query weights matrix and the transformed key weights matrix (block 812).

Turning now to FIG. 9, a generalized diagram is shown of a computing system 900 that performs efficient data storage and data transfer of machine learning data. As shown, computing system 900 includes the processing nodes 910 and 940, system memory 970, secondary storage 972, and local memory 980. The hardware, such as circuitry, of each of the first processing node 910 and the second processing node 940 provides a variety of functionalities. For example, the first processing node 910 includes numerous semiconductor dies such as the clients 920 and the second processing node 940 includes the clients 950. As used herein, a “client” refers to an integrated circuit with data processing circuitry and internal memory, which has tasks assigned to it by a scheduler such as an operating system (OS) scheduler or other. Examples of tasks are software threads of a process of an application, which are scheduled by the OS scheduler.

Examples of clients are a general-purpose central processing unit (CPU), a parallel data processing unit with a relatively wide single-instruction-multiple-data (SIMD) microarchitecture, a multimedia integrated circuit, one of a variety of types of an application specific integrated circuit (ASIC), a digital signal processor (DSP), a field programmable gate array (FPGA), one or more microcontrollers, and so forth. Other examples of the parallel data processing circuit are a graphics processing unit (GPU), an embedded inference processing unit (EIPU) or an embedded inference processing circuit, an artificial intelligence (AI) accelerator processing circuit (an accelerator device), a neural processing unit (NPU) or a neural processing circuit, a tensor processing unit (TPU) or a tensor processing circuit, a multiprocessing circuit, and so on. For example, the clients 920 of the processing node 910 include at least the host processing circuit 922, the integrated processing circuit 924, such as an integrated GPU (or iGPU), and the display controller 926. The clients 950 of the processing node 940 includes at least the accelerator circuit 952. Clock sources, such as phase lock loops (PLLs), an interrupt controller, a communication fabric, power controllers, and so forth are not shown in the computing system 900 for ease of illustration. It is also noted that the number of components of the computing system 900 and the number of subcomponents for those shown in FIG. 9, such as within the clients 920 and 950, can vary from implementation to implementation. There can be more or fewer of each component/subcomponent than the number shown for the computing system 900.

In an implementation, the processing node 910 is a system on a chip (SoC) in a semiconductor package on a motherboard and the system memory 970 is one of a variety of types of synchronous random-access memory (SRAM) in a separate semiconductor package on the motherboard. The processing node 910 accesses system memory 970 while processing tasks of a workload. The processing node 910 uses the system memory controller 932 to transfer data with the system memory 970 via a corresponding communication channel that is a point-to-point communication channel. The address information, command information, response data, payload data, header information, and other types of information are transferred on metal traces or wires that are accessible by only the single source and the single destination. In various implementations, processing node 940 uses the system memory controller 962 to transfer data with the system memory 970 via a corresponding communication channel that is also a point-to-point communication channel. In an implementation, the system memory controller 932, the system memory controller 962, and the system memory 970 support one of a variety of types of a Double Data Rate (DDR) communication protocol or one of a variety of types of a Low-Power Double Data Rate (LPDDR) communication protocol.

Secondary storage 972 is a lower level than system memory 970 in the memory hierarchy of computing system 900. Typically, secondary storage 972 is a hard disk drive (HDD) or solid-state drive (SSD) providing non-volatile data storage. The processing node 940 accesses the local memory 980 while processing tasks of a workload. Local memory 980 can be on-chip memory or off-chip memory. In an implementation, the processing node 940 is a system on a chip (SoC) in a semiconductor package on the motherboard and the local memory 980 is one of a variety of types of SRAM located nearby to processing node 940. In another implementation, processing nodes 910 and 940 are located on the same SoC. The processing node 940 uses the local memory controller 964 to transfer data with the local memory 980. In an implementation, the local memory controller 964 supports one of a variety of types of a Graphics Double Data Rate (GDDR) communication protocol.

Between input/output (I/O) controllers 930 and 960, the communication channel transfers data between integrated circuits of the processing nodes 910 and 940. In an implementation, the I/O interfaces 930 and 960 support a communication protocol such as the Peripheral Component Interconnect Express (PCIe) protocol. Similar to other interfaces, such as the system memory controllers 932 and 962 and local memory controller 964, the I/O controllers 930 and 960 include one or more queues for storing requests, responses, and messages, and include circuitry that builds packets for transmission, disassembles packets upon reception, and supports a particular communication protocol.

In various implementations, accelerator circuit 952 executes a variety of types of parallel data applications such as machine learning (ML) models. System memory 970 stores instructions describing one or more algorithms of machine learning (ML) model 974 that analyze data to generate one or more predictions or classifications. In various implementations, to generate predictions or classifications, ML model 974 has the functionality of ML model 200 (of FIG. 2), operations and equations of FIGS. 4B-4D, components 500 (of FIG. 5), processing stages 600 (of FIG. 6), and computational graph 700 (of FIG. 7). In some implementations, the ML model 974 is one of a variety of types of a large language model (LLM). Examples of these LLMs include the examples of LLMs described earlier for ML model 200 (of FIG. 2). In various implementations, ML model 974 is written by developers in one of a variety of high-level programming languages such as Python, R, Julia, C, C++, C#, and Java and so on.

Machine learning libraries can be used with these high-level programming languages to provide predefined modules to aid developers when building the ML application (ML model). Examples of the ML libraries are TensorFlow, Pytorch, Numpy, Keras, Matplotlib, Pandas and so on. A predefined module can be called similar to a function call and the predefined module includes a directed acyclic graph (DAG) providing a sequence of execution steps of a non-recurring computation. A predefined module can be called similar to a function call and the predefined module includes a directed acyclic graph (DAG) providing a sequence of execution steps of a non-recurring computation. The imported ML libraries are used to create computational graphs that provide the computational order of the ML nodes, layers and stages of the ML model. One of the predefined modules includes the functionality of similarity measurement function 622 (of FIG. 6) and similarity measurement function 792 (of FIG. 7) that performs the operations of Sim (Qₖ, Kᵢ)=exp (QₖK^{T}ᵢ/\sqrt{d}) as shown in the SoftMax self-attention operation 480 (of FIG. 4B) by approximating it with the quadratic Taylor expansion, decomposing the approximation using the Kronecker product, and replacing the Kronecker product with a compact Kronecker product. These steps are shown in operations and equations of FIGS. 4B-4D. Linear attention layer 977 utilizes these steps.

The imported ML libraries are used to create computational graphs that provide the computational order of the ML nodes, layers and stages of the ML model. For example, accelerator circuit 952 executes instructions of nodes, layers and stages of ML model 985 in a computational order of computational graph 982. Computational graph 982 has the form of computational graph 700 (of FIG. 7). ML model 985 stored in local memory 980 includes commands translated from instructions of ML model 974 stored in system memory 970. Computational graph 982 stored in local memory 980 is a copy of computational graph 976 stored in system memory 970. Linear attention layer 983 stored in local memory 980 is a copy of linear attention layer 977 stored in system memory 970.

Host processing circuit 922 begins processing the instructions of the ML model and a library uses a user mode driver (UMD) to translate function calls in the application to commands particular to a piece of hardware such as accelerator circuit 952. The commands are included in one or more of ML model 985 and computational graph 982 stored in local memory 980. Based on the computational graph 982, accelerator circuit 952 detects a next machine learning (ML) node to execute and retrieves required weights from the pruned weights 984. Accelerator circuit 952 executes the ML node using the retrieved weights. For example, accelerator circuit 952 adds the ML node to a work queue (or machine learning queue or scheduler queue) that includes a pointer to the storage location of the local memory 980 that stores the required weights of pruned weights 984. In various implementations, local memory 980 also stores calibration activation values (not shown). As described earlier, the intermediate data includes activation vectors, key vectors and value vectors.

Turning now to FIG. 10, a block diagram is shown of an apparatus 1000 that performs efficient data storage and data transfer of machine learning data. In one implementation, apparatus 1000 includes parallel data processing circuit 1002. As shown, parallel data processing circuit 1002 includes control circuit 1010, memory controller 1020, cache memory subsystem 1030 and processing elements 1040A-1040B. Examples of parallel data processing circuit 1002 are the same as examples of accelerator circuit 952 (of FIG. 9). In various implementations, parallel data processing circuit 1002 executes a variety of types of parallel data applications such as machine learning (ML) models. For example, parallel data processing circuit 1002 executes instructions of nodes, layers and stages of a ML model in a computational order of a computational graph such as computational graph 700 (of FIG. 7).

Parallel data processing circuit 1002 includes at least control circuit 1010, processing elements 1040A-1040B, cache memory subsystem 1030, and memory controller 1020. Each of processing elements 1040A-1040B includes the multiple compute circuits 1050A-1050N and multiple buffers such as input values buffer 1060, intermediate data buffer 1062, weights buffer 1064 and output values buffer 1066. It should be understood that the components and connections shown for parallel data processing circuit 1002 are merely representative of one type of processing circuit and does not preclude the use of other types of processing circuits for implementing the techniques presented herein. The apparatus 1000 also includes other components which are not shown to avoid obscuring the figure such as at least a communication fabric, one or more system buses, clock signal generating circuitry, power management circuitry, input/output (I/O) interfaces and so on. In other implementations, the parallel data processing circuit 1002 includes other components, omits one or more of the illustrated components, has multiple instances of a component even if only one instance is shown in the apparatus 1000, and/or is organized in other suitable manners. Also, each connection shown in apparatus 1000 is representative of any number of connections between components. Additionally, other connections can exist between components even if these connections are not explicitly shown in apparatus 1000.

Although a single memory controller 1020 is shown, it is possible and contemplated that parallel data processing circuit 1002 includes multiple memory controllers supporting one or more communication protocols with a variety of data storage devices. In an implementation, memory controller 1020 (and any other memory controller) directly communicates with each of the processing elements 1040A-1040B and cache memory subsystem 1030 and includes circuitry for supporting communication protocols and queues for storing requests and responses. As part of executing an application, such as a ML model, a host CPU (not shown) launches kernels to be executed by parallel data processing circuit 1002. Control circuit 1010 receives kernels from the host CPU either directly or via system memory and determines when to dispatch kernels for execution on compute circuits 1050A-1050N of processing elements 1040A-1040B.

Parallel threads executing on compute circuits 1050A-1050N read data from and write data to the cache memory subsystem 1030, vector general-purpose registers, scalar general-purpose registers, and one or more of buffers 1060-1066. In various implementations, the circuitry of processing element 1040B is a replicated instantiation (or silicon integrated circuit copy) of the circuitry of processing element 1040A. In some implementations, each of the processing elements 1040A-1040B is a chiplet. As used herein, a “chiplet” is a semiconductor die (or die) fabricated separately from other dies, and then interconnected with these other dies in a single integrated circuit in the multi-chip module (MCM). On a single silicon wafer, multiple chiplets can be fabricated as multiple instances of particular integrated circuitry. A first silicon wafer (or first wafer) is fabricated with multiple instances of integrated circuitry of a first chiplet, and this first wafer is diced using laser cutting techniques to separate the multiple copies of the first chiplet. A second silicon wafer (or second wafer) is fabricated with multiple instances of integrated circuitry of a second chiplet, and this second wafer is diced using laser cutting techniques to separate the multiple copies of the second chiplet.

In an implementation, each of the multiple compute circuits 1050A-1050N includes one or more vector processing circuits with circuitry of multiple parallel computational lanes of simultaneous execution. These parallel computational lanes operate in lockstep. In various implementations, the data flow within each of the lanes is pipelined. Pipeline registers are used for storing intermediate results and circuitry for arithmetic logic units (ALUs) perform integer arithmetic, floating-point arithmetic, Boolean logic operations, branch condition comparisons and so forth. These components are not shown for ease of illustration. Each of the ALUs within a given row across the lanes includes the same circuitry and functionality, and operates on the same instruction, but different data, such as a different data item, associated with a different thread.

In addition to the multiple vector processing circuits, compute circuits 1050A-1050N also include an assigned number of vector general-purpose registers (VGPRs), an assigned number of scalar general-purpose registers (SGPRs), and an assigned data storage space of one or more of buffers 1060-1066. Schedulers in one or more of control circuit 110, processing elements 1040A-1040B and compute circuits 1050A-1050N receive instructions, such as instructions of stages, layers and nodes of a ML model, and determine when to execute the instructions.

As described earlier, for methods 800 and 1100, a computing system includes multiple processing circuits. Examples of the host processing circuit of the multiple processing circuits is host processing circuit 922 (of FIG. 9). Examples of the accelerator circuit of the multiple processing circuits are accelerator circuit 952 (of FIG. 9) and parallel data processing circuit 1002 (of FIG. 10). For the methods 800 and 1100, the multiple processing circuits execute a variety of types of parallel data applications such as a variety of types of machine learning (ML) models.

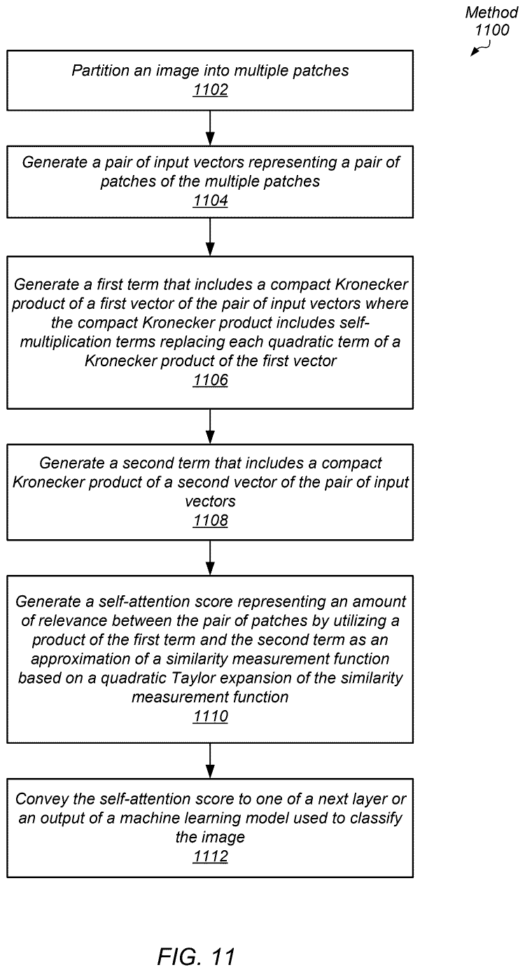

Referring to FIG. 11, a generalized diagram is shown of a method 1100 for performing efficient data storage and data transfer of machine learning data. For purposes of discussion, the steps in this implementation are shown in sequential order. However, in other implementations some steps occur in a different order than shown, some steps are performed concurrently, some steps are combined with other steps, and some steps are absent.

One of the processing circuits partition an image into multiple patches (block 1102). An example of the image is image 110 (of FIG. 1) and examples of the patches are patches 112-116 (of FIG. 1). The accelerator circuit generates a pair of input vectors representing a pair of patches of the multiple patches (block 1104). Examples are input vectors 306 (of FIG. 3). The accelerator circuit generates a first term that includes a compact Kronecker product of a first vector of the pair of input vectors where the compact Kronecker product includes self-multiplication terms replacing each quadratic term of a Kronecker product of the first vector (block 1106). An example of the first term is either one of the two terms of equation (7) and equation (8) of Similarity Measurement Operation 485 (of FIG. 4C). The compact Kronecker product is shown in equation (11) of operations 487 (of FIG. 4D), which is derived from the Kronecker product and its elements in equations (9) and (10) of operations 486 (of FIG. 4D). The compact Kronecker product has a number of elements in its output length equal to a sum of one and twice the size of a dimension of the pair of input vectors (2d+1).

The accelerator circuit generates a second term that includes a compact Kronecker product of a second vector of the pair of input vectors (block 1108). Similar to the first term, an example of the second term is either one of the two terms of equation (7) and equation (8) of Similarity Measurement Operation 485 (of FIG. 4C). The second term also uses the compact Kronecker product. The accelerator circuit generates a self-attention score representing an amount of relevance between the pair of patches by utilizing a product of the first term and the second term as an approximation of a similarity measurement function based on a quadratic Taylor expansion of the similarity measurement function (block 1110). The accelerator circuit uses the two generated terms to generate the product as shown in equation (7) of Similarity Measurement Operation 485 (of FIG. 4C). The product provides the quadratic Taylor expansion of the similarity measurement function as shown in Similarity Measurement Operation 482 (of FIG. 4B). The product relies on the compact Kronecker product shown in equation (11) of operations 487 (of FIG. 4D), which is derived from the Kronecker product and its elements in equations (9) and (10) of operations 486 (of FIG. 4D). The compact Kronecker product has a number of elements in its output length equal to a sum of one and twice the size of a dimension of the pair of input vectors (2d+1). The accelerator circuit conveys the self-attention score to one of the next layers or an output of a machine learning model used to classify the image (block 1112).

It is noted that one or more of the above-described implementations include software. In such implementations, the program instructions that implement the methods and/or mechanisms are conveyed or stored on a computer readable medium. Numerous types of media which are configured to store program instructions are available and include hard disks, floppy disks, CD-ROM, DVD, flash memory, Programmable ROMs (PROM), random access memory (RAM), and various other forms of volatile or non-volatile storage. Generally speaking, a computer accessible storage medium includes any storage media accessible by a computer during use to provide instructions and/or data to the computer. For example, a computer accessible storage medium includes storage media such as magnetic or optical media, e.g., disk (fixed or removable), tape, CD-ROM, or DVD-ROM, CD-R, CD-RW, DVD-R, DVD-RW, or Blu-Ray. Storage media further includes volatile or non-volatile memory media such as RAM (e.g., synchronous dynamic RAM (SDRAM), double data rate (DDR, DDR2, DDR3, etc.) SDRAM, low-power DDR (LPDDR2, etc.) SDRAM, Rambus DRAM (RDRAM), static RAM (SRAM), etc.), ROM, Flash memory, non-volatile memory (e.g., Flash memory) accessible via a peripheral interface such as the Universal Serial Bus (USB) interface, etc. Storage media includes microelectromechanical systems (MEMS), as well as storage media accessible via a communication medium such as a network and/or a wireless link.

Additionally, in various implementations, program instructions include behavioral-level descriptions or register-transfer level (RTL) descriptions of the hardware functionality in a high-level programming language such as C, or a design language (HDL) such as Verilog, VHDL, or database format such as GDS II stream format (GDSII). In some cases, the description is read by a synthesis tool, which synthesizes the description to produce a netlist including a list of gates from a synthesis library. The netlist includes a set of gates, which also represent the functionality of the hardware including the system. The netlist is then placed and routed to produce a data set describing geometric shapes to be applied to masks. The masks are then used in various semiconductor fabrication steps to produce a semiconductor circuit or circuits corresponding to the system. Alternatively, the instructions on the computer accessible storage medium are the netlist (with or without the synthesis library) or the data set, as desired. Additionally, the instructions are utilized for purposes of emulation by a hardware-based type emulator from such vendors as Cadence®, EVER, and Mentor Graphics®.

Although the implementations above have been described in considerable detail, numerous variations and modifications will become apparent to those skilled in the art once the above disclosure is fully appreciated. It is intended that the following claims be interpreted to embrace all such variations and modifications.

What is claimed is:

1. An apparatus comprising:
circuitry configured to:
generate a pair of input vectors representing a pair of input values sent to a machine learning model;
generate a self-attention score representing an amount of relevance between the pair of input values based on an approximation of a similarity measurement function comprising a product of two terms, wherein at least a first term of the two terms comprises a compact Kronecker product of a first vector of the pair of input vectors; and
convey the self-attention score to one of a next layer or an output of the machine learning model.

2. The apparatus as recited in claim 1, wherein the approximation of the similarity measurement function comprising the product of two terms is based on a quadratic Taylor expansion of the similarity measurement function.

3. The apparatus as recited in claim 1, wherein the compact Kronecker product of the first vector comprises self-multiplication terms replacing each quadratic term of a Kronecker product of the first vector.

4. The apparatus as recited in claim 3, wherein the compact Kronecker product has a number of elements in its output length equal to a sum of one and twice a size of a dimension of the pair of input vectors.

5. The apparatus as recited in claim 3, wherein the circuitry is configured to generate a second term of the two terms comprising a compact Kronecker product of a second vector of the pair of input vectors.

6. The apparatus as recited in claim 5, wherein the circuitry is configured to perform a same set of transformation steps on each of the first term and the second term comprising rearranging an order of elements of each of the first term and the second term in a same manner.

7. The apparatus as recited in claim 1, wherein each of the pair of input values is a patch of a plurality of patches of an image sent to the machine learning model for classification.

8. A method, comprising:
generating, by a processing circuit, a pair of input vectors representing a pair of input values sent to a machine learning model;
generating, by the processing circuit, a self-attention score representing an amount of relevance between the pair of input values based on an approximation of a similarity measurement function comprising a product of two terms, wherein at least a first term of the two terms comprises a compact Kronecker product of a first vector of the pair of input vectors; and
conveying, by the processing circuit, the self-attention score to one of a next layer or an output of the machine learning model.

9. The method as recited in claim 8, wherein the approximation of the similarity measurement function comprising the product of two terms is based on a quadratic Taylor expansion of the similarity measurement function.

10. The method as recited in claim 8, wherein the compact Kronecker product of the first vector comprises self-multiplication terms replacing each quadratic term of a Kronecker product of the first vector.

11. The method as recited in claim 10, wherein the compact Kronecker product has a number of elements in its output length equal to a sum of one and twice a size of a dimension of the pair of input vectors.

12. The method as recited in claim 10, further comprising generating, by the processing circuit, a second term of the two terms comprising a compact Kronecker product of a second vector of the pair of input vectors.

13. The method as recited in claim 12, further comprising performing, by the processing circuit, a same set of transformation steps on each of the first term and the second term comprising rearranging an order of elements of each of the first term and the second term in a same manner.

14. The method as recited in claim 8, wherein each of the pair of input values is a patch of a plurality of patches of an image sent to the machine learning model for classification.

15. A computing system comprising:
a memory configured to store an image; and
a processing circuit configured to execute a plurality of layers of a machine learning model in a computation order specified by a computational graph;
wherein responsive to a request to classify the image, the processing circuit is configured to:
generate a plurality of input values, each being a non-overlapped patch of the image;
generate a pair of input vectors representing a pair of input values of the plurality of input values;
generate a self-attention score representing an amount of relevance between the pair of input values based on an approximation of a similarity measurement function comprising a product of two terms, wherein at least a first term of the two terms comprises a compact Kronecker product of a first vector of the pair of input vectors; and
convey the self-attention score to one of a next layer or an output of the machine learning model.

16. The computing system as recited in claim 15, wherein the approximation of the similarity measurement function comprising the product of two terms is based on a quadratic Taylor expansion of the similarity measurement function.

17. The computing system as recited in claim 15, wherein the compact Kronecker product of the first vector comprises self-multiplication terms replacing each quadratic term of a Kronecker product of the first vector.

18. The computing system as recited in claim 17, wherein the compact Kronecker product has a number of elements in its output length equal to a sum of one and twice a size of a dimension of the pair of input vectors.

19. The computing system as recited in claim 17, wherein the processing circuit is configured to generate a second term of the two terms comprising a compact Kronecker product of a second vector of the pair of input vectors.

20. The computing system as recited in claim 19, wherein the processing circuit is configured to perform a same set of transformation steps on each of the first term and the second term comprising rearranging an order of elements of each of the first term and the second term in a same manner.
